(19) United States
(12) Patent Application Publication
(10) Pub. No.: US 2005/0238023 A1
(43) Pub. Date: Oct. 27, 2005

(54) Audio FSK encoded digital data packet embedded in the audio message portion of an EAS protocol transmission, and related methods

(76) Inventors: Bruce W. Robertson, Oracle, AZ (US); Thomas A. Wood, Salt Lake City, UT (US)

Correspondence Address: Lawrence R. Oremland, P.C.;Suite C-214, 5055 E. Broadway Boulevard, Tucson, AZ, 85711, US

(21) Appl. No.: 11/091,735

(22) Filed: Mar. 28, 2005

Related U.S. Application Data
(60) Provisional application No. 60/556,609, filed on Mar. 26, 2004.

(51) Int. Cl. H04L 12/66; H04L 12/28; H04L 12/56

(52) U.S. Cl. 370/392

(57) ABSTRACT

The present invention provides an audio FSK encoded digital data packet embedded in the audio message portion of an EAS protocol transmission, and to methods for encoding and for recognizing and decoding the data packet. A digital audio FSK encoded digital data packet embedded in the audio message portion of an EAS protocol transmission comprises a packet header, control codes, and content data. The data packet header identifies the beginning of the data packet. The control codes provide structural information about the content data segment of the data packet. The content data comprising at least primary text and/or other primary data as described by the control codes, and optionally, containing auxiliary device control data and content encryption data as described by optional control codes, and the end of content data identifying the end of the embedded data packet, all from which an EAS audio FSK decoder may reconstruct the original embedded digital data.

### RELATED APPLICATION/CLAIM OF PRIORITY

This application is related to and claims priority from U.S. Provisional Application Ser. No. 60/556,609, entitled Audio FSK encoded digital data packet embedded in the audio message portion of an EAS protocol transmission, and related methods, filed Mar. 26, 2004, and which provisional application is incorporated by reference herein.

### BACKGROUND AND SUMMARY OF THE PRESENT INVENTION

The present invention relates to an audio FSK encoded digital data packet embedded in the audio message portion of an EAS protocol transmission, and to methods for encoding and for recognizing and decoding the data packet.

The FCC (Federal Communications Commission), SBE (Society of Broadcast Engineers), PPW (Partnership for Public Warning), and NAD (National Association of the Deaf) along with local and state emergency managers have recognized the need to add information to current EAS communications. An EAS ruling, released in December of 1994, defined the protocol and operational requirements for the nation's revised EBS system. The protocol defines a series consisting of headers, two tone alerting, an audio envelope and end of message codes. The initiating organization, the event, the time of release, the anticipated duration, and retransmission identifier is contained in the header. The familiar two-tone signal previously used in EBS has been retained for alerting. The protocol listed “Audio, Video, Text” in the audio portion of the protocol and is specified to be a maximum of two minutes in duration. The end of message code then brackets and completes the alerting transmission. The information available in the header alerted to a condition but did not provide adequate details upon which to base an intelligent response to that alert.

In an effort to provide that critical additional information the FCC was asked to further define the “Video” and “Text” portions indicated in the original release. The initial solicitation for this definition occurred at a Dec. 9, 1994 meeting immediately after the release of the ruling. The FCC did not at that time nor has it since provided that definition. The FCC asked on several occasions between 1994 and 2003 how this additional information could be added to the EAS protocol.

In 2002 the Society of Broadcast Engineers (SBE) recommended a method to add information to the EAS communications. On Mar. 20, 2001 the FCC announced this consideration in adopting a Notice of Proposed Rule Making which stated: “The NPRM also invites comment on requests that the Commission amend Part 11 to add a protocol for the transmission of text information following the EAS alert; amend - - - ”. In EM DOCKET NO. 01-66 the FCC refused the SBE recommendation and requested additional information by stating: “Under SBE's suggestion, text information would be transmitted immediately following the existing EAS message format, using the existing Audio Frequency Shift Keying (“AFSK”) technique. By providing the text message following the existing EAS message, SBE states that text can be incorporated without affecting existing decoders. We seek comment on this suggestion, but we note that at this time, we have no information or data to support the addition of text messaging to the EAS system using the AFSK technique or any other scheme. In addition, we are aware of no comprehensive field tests that have been conducted to show the viability of different text formats. Moreover, SBE provides no data in its petition on the costs of adding text processing to EAS equipment. Nevertheless, we seek comment on whether we should amend the rules to provide broadcasters and cable operators with additional text transmission options.”

Against this background, applicants recognized a need for additional information to be added to an EAS communication, past efforts to define a method that would add the information to EAS communications, and the ongoing requests for further development or definition. In response to this need applicants have developed a method for embedding additional information inside the defined protocol. Information can be economically embedded in this manner without affecting existing decoders. The embedded information is a method of providing the “Video” and the “Text” information noted in the original protocol definition. Summary of the Present Invention

The present invention relates to an audio FSK encoded digital data packet embedded in the audio message portion of an EAS protocol transmission, and to methods for encoding and for recognizing and decoding the data packet.

According to one aspect of the present invention, a digital audio FSK encoded digital data packet is embedded in the audio message portion of an EAS protocol transmission. The packet comprises a packet header, control codes, and content data. The data packet header identifies the beginning of the data packet, the control codes provide structural information about the data packet, the content data comprises at least primary text and/or other data as described by the control codes, and the end of content data identifies the end of the embedded data packet. The original embedded digital data may be reconstructed by an EAS audio FSK decoder.

The present invention also provides a method of encoding at least text and/or general digital data into digital audio FSK for analog transmission during the audio message portion of an EAS protocol transmission. A data packet comprising a packet header, control codes, and primary text and/or general digital content data is encoded into digital audio, and transmitted as analog audio after the start of the analog audio message portion of an EAS protocol transmission and finishes before the end of the analog audio message portion of the EAS protocol transmission.

Additionally, the present invention provides a method of recognizing and decoding a digital data packet from an analog audio transmission of the audio message portion of an EAS protocol transmission. The audio message portion of an EAS protocol transmission is converted into a digital format, from which a data packet comprising a packet header, control codes, and primary text and/or general digital content data is recognized and decoded.

Further features of the present invention will become apparent from the following detailed description and the accompanying drawings.

### BRIEF DESCRIPTION OF THE DRAWINGS

FIG. 1 is a schematic illustration of an EAS protocol transmission;

FIG. 2 is a schematic illustration of the structure of a normal EAS protocol; and that protocol with the proposed digital data packet;

FIG. 3 is an example of facts available in a current AMBER alert and facts that are made available with a digital data packet, according to the present invention, embedded in the EAS protocol transmission; and

FIG. 4 is a schematic illustration of the components of a data packet that is embedded in, and identified and decoded from, an EAS protocol transmission, according to the principles of the present invention.

FIG. 5 expands on the EAS protocol transmission shown in FIG. 1 showing information exchange with external data bases that is enabled by this method.

### DETAILED DESCRIPTION

As described above, the present invention relates to an audio FSK encoded digital data packet embedded in the audio message portion of an EAS protocol transmission, and to methods for encoding and for recognizing and decoding the data packet.

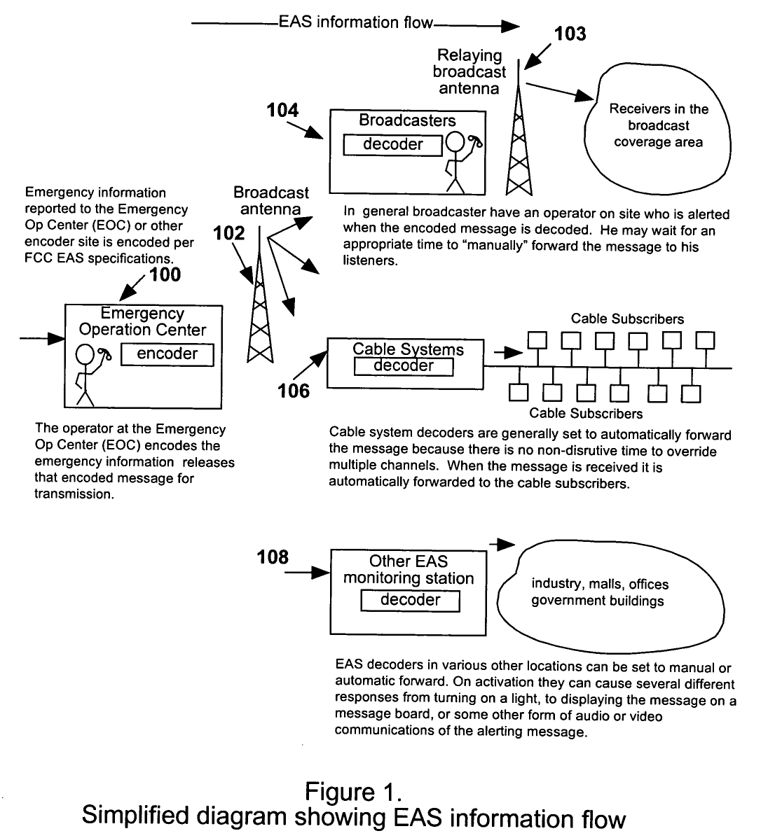

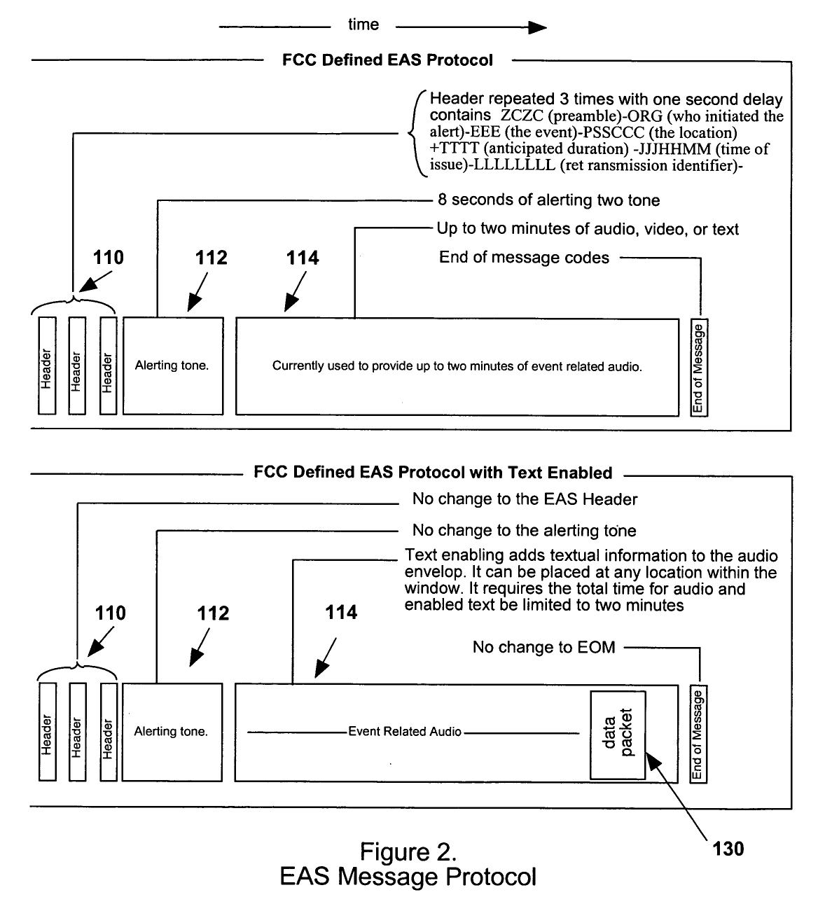

Initially, it is believed helpful to provide some additional background on EAS transmissions. Referring to FIGS. 1 and 2, In general, when an emergency operation center 100 is notified of an emergency situation, an operator at the emergency operations center 100 encodes the emergency information, according to FCC specifications, and releases the encoded message for transmission. The EAS protocol is strictly audio-based tones and spoken information sent out over radio and TV broadcast facilities 102. These can be decoded by receivers (e.g. broadcast decoders 104, cable system decoders 106 and other EAS monitoring system decoders 108), and more specifically by computer hardware interfacing to the decoder receivers. Such decoders can be activated to cause different types of responses, e.g. turning on a light, displaying the message on a message, or some other form of audio or video communications. The Broadcast station relays the EAS information by broadcasting to its listeners or viewers over relaying Broadcast tower 103. The cable system relays the EAS information by placing it on the various channels on the cable system. Other EAS decoders communicate the EAS information by signs, sirens, or other forms.

Digital information encoding is achieved using short sequences of two specific audio frequencies. One frequency (1562.5 Hz) encodes bit value 0, the other (2083.3 Hz) bit value 1. This is known as AFSK (Audio Frequency Shift Keying) encoding. The FCC has mandated the two frequencies that are used. As illustrated in FIG. 2, using this encoding spec, EAS messages must include three (3) bursts of header data 110. The headers consist of 16 bytes of preamble data, followed by some number of bytes of basic text information. This information is minimal, but is enough to identify the type of alert; it's duration, and the region for which it is active. The three headers 110 are identical. They are repeated to add some reliability to the scheme.

The header data is followed by a short duration audio attention signal 112 (8 to 25 seconds). This is made up of two pure frequencies (again mandated by the FCC). This signal does not encode anything. It is presumably meant to get the attention of listeners/viewers.

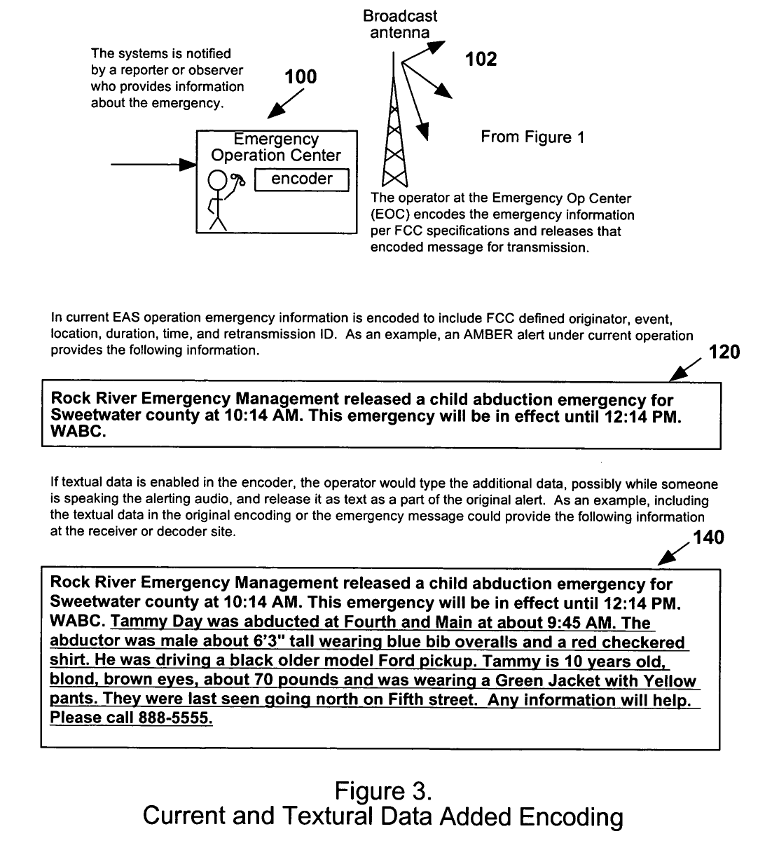

The FCC states that up to two minutes of audio, video or text messages may be broadcast after the header/attention signal, as illustrated schematically at 114 in FIG. 2. The meaning of audio transmission is obvious enough, but the FCC does not state how text or video would be sent. The FCC does state that a decoder must be able to record or store up to two minutes of audio from this portion of the alert. There are no known restrictions on the content of the audio portion from the FCC (other than those that government can be expected to regulate on speech in the context of an emergency situation). Thus, in current EAS operation, emergency information is encoded to include FCC defined originator, event, location, duration, time and retransmission ID. As an example, an AMBER alert under current operation of the EAS protocol provides the information shown at 120 in FIG. 3. The data packet 130, which is embedded in the EAS audio portion 114, according to the principles of the present invention, is described further below, and provides the type of additional information shown at 140 in FIG. 3.

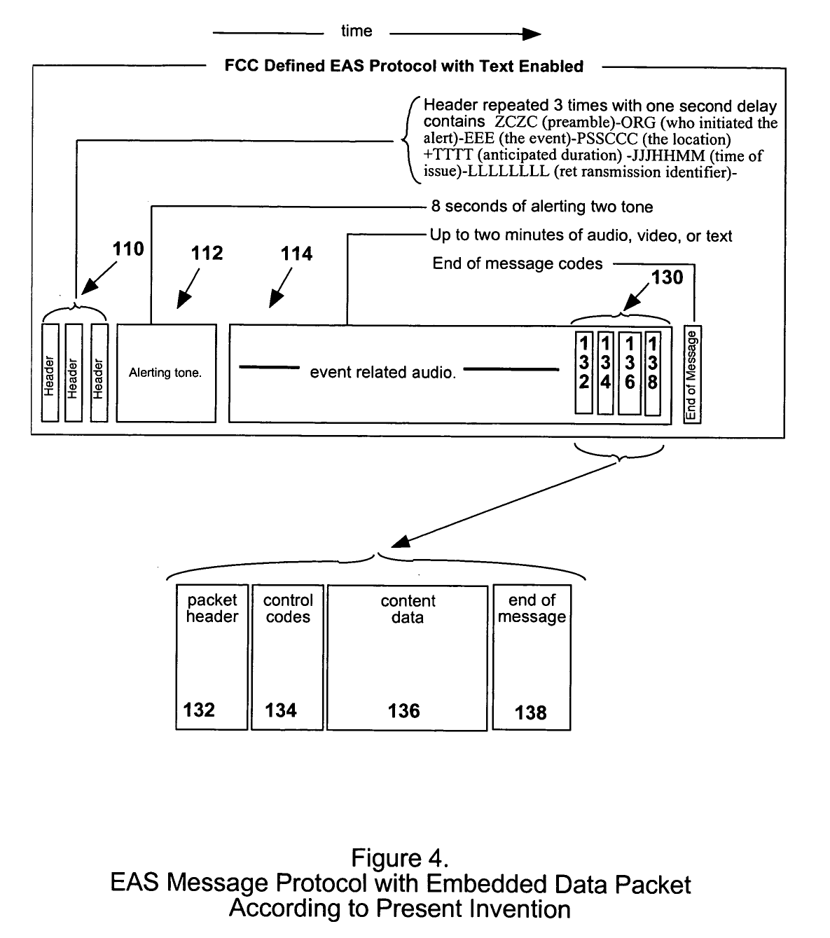

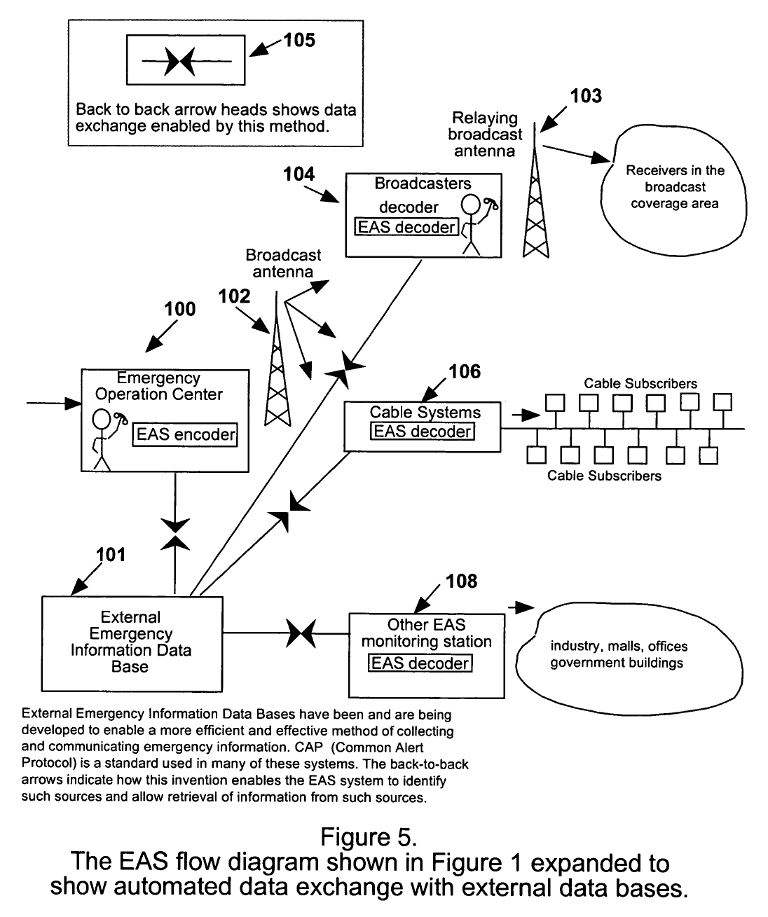

The present invention provides digital audio FSK encoded digital data packet embedded in the audio message portion 114 of an EAS protocol transmission. As schematically illustrated in FIG. 4, the digital data packet 130 comprises a packet header 132, control codes 134, content data 136 and end of packet data 138. The data packet header 132 identifies the beginning of the data packet. The control codes 134 provide structural information about the content data 136, e.g. whether the data is textual, compressed, includes images, etc. The control codes also define the length of the content data 136 and checksum information for data verification. The control codes may optionally include codes relating to the control of auxiliary devices and/or the disposition of the content data at the receiving end, e.g. GPI output relay assertion and/or data routing. Also, the control codes may optionally define encryption methods used to encrypt the content data. The content data 136 comprising at least primary text and/or other primary data as described by the control codes. Optionally, the content data 136 may contain extra data needed to define the auxiliary control as well as to facilitate decryption. The end of content data 136 signifies the end of the packet information payload. In the illustrated embodiment, this is framed by the end of packet data 138 which pads the end of the embedded data packet, and includes a specific data entry followed by a second of audio silence, that identifies the end of the data packet. The embedded data packet 130 enables the original embedded digital data to be identified and reconstructed by an EAS audio FSK decoder (e.g. decoders of the type shown at 104, 106 and 108 in FIG. 1). Applicants prefer a variably sized part of the 2-minute audio portion to embed a small (up to about 10000 bytes) but very useful amount of digital data to be decoded and used by enhanced alert decoders. This will enrich the content received by the decoder. The content can be used by the EAS response infrastructure to add needed detail to the messages displayed within video systems. For instance, the hearing impaired would be able to read extensive alert details. As an example, FIG. 3 shows, at 140, the type of message that can be encoded into the EAS audio transmission, according to the principles of the present invention. FIG. 5 expands on the diagram for EAS shown in FIG. 1, showing how an external data base 101 can provide the encoder 100 with information for placement in the data packet. The external data base 101 can then store pictures, audio or additional text relating to the specific emergency and make that data available to the decoders as shown in the communication exchange lines 105.

According to the invention, the data packet 130 is encoded into digital audio that is embedded in the EAS protocol transmission, and transmitted as analog audio after the start of the analog audio message portion of an EAS protocol transmission and finishing before the end of the analog audio message portion of an EAS protocol transmission. EAS certification requires the ability to insert an event-associated audio alerting message into the EAS message and defines the portion designated to carry this audio portion. Enabling the data packet comprises constructing the packet information into the header, control, content, and end configuration and putting that packet configuration into an AFSK audio stream, using the same AFSK specification as defined in the FCC ruling. This AFSK audio stream is then made a part of the audio insertion process. The data packet 130 can be placed before, during or after the audio alerting message, although for practical purposes, placement after the audio alerting message is preferable.

Moreover, according to the present invention, the EAS protocol transmission, embedded in the digital audio portion of the EAS protocol and transmitted as analog audio after the start of the analog audio message portion of an EAS protocol transmission and finishing before the end of the analog audio, is recognized and decoded from this digital audio portion of the transmission. After receiving and being alerted by the EAS header in the incoming audio, the decoder continues to monitor the incoming message for the data packet header. Since the AFSK defined in the encoding is to the same specifications as the AFSK being monitored in decoding, there is not a requirement for additional FSK discrimination. When the packet header is detected the data is read and passed through, to the decoder output. Presentation and distribution decisions are then made at the output of the decoder where all of the EAS alerting and data packet information available. The packet control codes identify the data and any external response that has been defined for that systems operation. For example, packet control codes can identify the contents as normal text or compressed text. Further packet control codes could identify the content as an image that may contain a face or an evacuation route. This usage satisfies the “Video” note in the original protocol definition. Control codes defined for a specific EAS area can automatically activate essential functions within the system. Sufficient control codes are included to identify the text type, provide external activation as noted, plus allow this usage to be expanded in the future.

As an example, the components of the embedded data packet 130 can be configured as follows:

*****Packet Header 132*******
1 second of silence
2 bytes of 0x00

Meaningless pad for the following header data, allows for transition from audio
silence squelch

16 bytes of 0xAC

This identifies the data packet section to an FSK decoder.

4 bytes ′DATA

This further identifies the data packet section.

1 byte version number

This identifies the data packet version #

1 byte reserved

Reserved for future use, 0 for now

*****Control Data 134*******
1 byte primary data
encoding type

This identifies the data encoding type of primary data
in the Content Data section. Values defined elsewhere.

1 byte compression
type

This identifies the optional data compression scheme used on the Content Data
section. Zero means no-compression. Values defined elsewhere.

1 byte encryption
type

This identifies the optional data encryption scheme used on the Content Data section.
The type determines if any extra data is defined and included in the Content Data
section and whose length is defined in the encryption section length field. Zero means
no-encryption. Values defined elsewhere.

1 byte control
type

This identifies the optional auxiliary control section scheme that may be included
in the Content Data section. The type determines if any extra data is defined and
included in the Content Data and whose length is defined in the control section
length field. Zero means no-auxiliary control. Values defined elsewhere.

2 bytes encryption
section length

In bytes of data, little-endian. If non-zero, the data immediately follows encoded
data length field, and begins the Content Data section.

2 bytes control
section length

In bytes of data, little-endian. If non-zero, this data immediately follows
encryption control data in the Content Data section.

4 bytes primary encoded
data length

In bytes of data that comprises the last part of the Content Data, little-endian.

4 bytes content data.
checksum

Checksum for the entire Content Data section, little-endian. If zero, unused.

4 bytes reserved

Reserved for future use. 0 for now.

*****Content Data 136*******
0 . . . n bytes of encryption control data, unencrypted,

as specified by encryption type and encryption length.

0 . . . n bytes of auxiliary control data,

as specified by control type and control section length.

n bytes of primary encoded data
*****End of Packet Data 138*******
2 bytes of 0xFF

EOF indicator, pads data section, allows for audio squelch to silence, content is
meaningless

1 second of silence

Accordingly, applicants have provided an embedded structure, and related methods whereby a digital audio FSK encoded digital data packet can be embedded in the audio message portion of an EAS protocol transmission, and identified and decoded from the transmission, to provide particularly useful information from the digital audio portion of an EAS protocol transmission. With the foregoing principles in mind, it is believed that various ways to use the digital audio portion of an EAS protocol transmission will be apparent to those in the art.

1. A digital audio FSK encoded digital data packet embedded in the audio message portion of an EAS protocol transmission, and configured such that the original embedded digital data may be reconstructed by an EAS audio FSK decoder.

2. A digital audio FSK encoded digital data packet as described in claim 1, wherein the packet comprises a packet header, control codes, and content data, the data packet header identifying the beginning of the data packet, the control codes providing structural information about the content data, and the content data comprising at least primary text and/or other primary data, as described by the control codes, with the end of the content data identifying the end of the embedded data packet, all from which the original embedded digital data may be reconstructed by an EAS audio FSK decoder.

3. A digital audio FSK encoded digital data packet as defined in claim 2, wherein the control codes optionally permit predefined auxiliary device control methods, and the content data correspondingly provides for a variable length section of auxiliary device control data for implementing the external device control.

4. A digital audio FSK encoded digital data packet as defined in claim 3, wherein the control codes optionally permit predefined encryption options for sensitive portions of the content data, and the content data correspondingly provides for a variable length section of unencrypted encryption control data to facilitate the decryption of the sensitive content data portions, defined as the primary encoded data and the optional auxiliary device control data sections of the content data.

5. A digital audio FSK encoded digital data packet as defined in claim 2, wherein the control codes optionally permit predefined encryption options for sensitive portions of the content data, and the content data correspondingly provides for a variable length section of unencrypted encryption control data to facilitate the decryption of the sensitive content data portions, defined as the primary encoded data and the optional auxiliary device control data sections of the content data.

6. A method of encoding at least primary text and/or general digital data into digital audio FSK for analog transmission during the audio message portion of an EAS protocol transmission, comprising the steps of encoding a data packet comprising a packet header, control codes, and primary text and/or general digital content data into digital audio that is embedded in the EAS protocol transmission, and transmitting the data packet as analog audio after the start of the analog audio message portion of an EAS protocol transmission and finishing before the end of the analog audio message portion of an EAS protocol transmission.

7. A method as set forth in claim 6, wherein the control codes optionally permit encoding a predefined auxiliary device control method, and the content data correspondingly provides for encoding a variable length section of auxiliary device content data for implementing the external device control.

8. A method as set forth in claim 7, wherein the control codes optionally permit encoding a predefined encryption option for sensitive portions of the content data, and the content data correspondingly provides for encoding a variable length section of unencrypted encryption control data to facilitate the decryption of the sensitive content data portions, defined as the primary encoded data and the optional auxiliary device control data sections of the content data.

9. A method as set forth in claim 6, wherein the control codes optionally permit encoding a predefined encryption option for sensitive portions of the content data, and the content data correspondingly provides for encoding a variable length section of unencrypted encryption control data to facilitate the decryption of the sensitive content data portions, defined as the primary encoded data and the optional auxiliary device control data sections of the content data.

10. A method of recognizing, decoding, and applying a digital data packet from an analog audio transmission of the audio message portion of an EAS protocol transmission that includes EAS client information, comprising the steps of converting the audio message portion of an EAS protocol transmission into a digital format, recognizing and decoding from this digital audio a data packet comprising a packet header, control codes, and primary text and/or general digital content data, and adding the decoded text or digital content to the EAS alert information that may be re-broadcast or forwarded by cable systems or other decoder locations.

11. A method as defined in claim 10, wherein decoding specific optional control codes indicate a predefined auxiliary device control task, and decoding the corresponding section of the content data provides information for implementing specific external device control, allows for software application of this information on the decoding device in order to achieve the desired device control.

12. A method as defined in claim 11, wherein decoding specific control codes indicate predefined encryption algorithms used for encrypting sensitive portions of the content data, and decoding the corresponding unencrypted section of content data provides for any extra encryption control information to facilitate the decryption of the primary encoded data and the optional auxiliary device control data sections of the content data.

13. A method as defined in claim 10, wherein decoding specific control codes indicate predefined encryption algorithms used for encrypting sensitive portions of the content data, and decoding the corresponding unencrypted section of content data provides for any extra encryption control information to facilitate the decryption of the primary encoded data and the optional auxiliary device control data sections of the content data.
